(19) United States
(12) Patent Application Publication
(10) Pub. No.: US 2006/0119146 A1
(43) Pub. Date: Jun. 8, 2006

(54) Bicycle seat

(76) Inventor: Douglas Webler, Northborough, MA (US)

Correspondence Address: GREENBERG TRAURIG, LLP, ONE INTERNATIONAL PLACE, 20th FL, ATTN: PATENT ADMINISTRATOR, BOSTON, MA, 02110, US

(21) Appl. No.: 11/003,038

(22) Filed: Dec. 2, 2004

(51) Int. Cl. B62J 1/00

(52) U.S. Cl. 297/195.1

(57) ABSTRACT

A bicycle seat that can eliminate or minimize the incidence of bicycle seat neuropathy, while permitting a rider to perform turning maneuvers without compromising the stability needed for the turn is provided. The bicycle seat includes a platform portion having an upper surface upon which opposing ischial bones of a rider can be supported. The seat may also include a horn portion extending axially forward of the platform portion, and a depression positioned between the platform portion and the horn portion. The depression includes a sufficient depth, so as to allow the rider in a riding position to avoid pressure against the perineal nerves and vessels.

### FIELD OF THE INVENTION

The present invention relates to bicycle seats, and more particularly, to bicycle seats designed to minimize bicycle seat neuropathy.

### RELATED ART

Bicycle seat neuropathy is one of the more common injuries reported by cyclists. It has been noted that bicycle seat shape may be the major extrinsic factor in the development of bicycle seat neuropathy. The injuries and symptoms may be the results of the cyclist/rider supporting his body weight on a narrow bicycle seat for an extended period, and are believed to be related to either vascular or neurologic injuries to the nerves and blood vessels within the perineum or perineal area, i.e., the sensitive area between the anus and the scrotum. Such injuries may lead to, among other things, inflammation, plaque formation, calcification, blood flow blockage, and may have direct correlation to an increased incidence of erectile dysfunction, for instance, impotence, observed in male bicycle riders.

A wide frequency range has been reported for bicycle seat neuropathy. A study presented at the 1999 Annual Meeting of the American Society of Sports Medicine estimated that between 6% and 21% of male cyclists have experienced symptoms. Another study surveyed 260 cyclists participating in a long-distance bike tour that was 540 km in length. Of responding males, 22% (35 of 160) reported symptoms of either numbness or pain in the pudendal area (i.e., area around the external genital organs). Thirty-three males reported penile numbness, with 10 male cyclists reporting symptoms that lasted longer than one week. Twenty-one males (13%) reported symptoms of impotence, 11 of whom experienced symptoms for longer than one week and 3 of whom reported impotence lasting longer than one month. In a similar study looking at symptoms of cyclists participating in a 500-mile bicycle tour, of the participating cyclists, 45% reported at least mild and transient perineal numbness. Ten percent reported the symptoms as severe, and 2% of the cyclists had to temporarily stop riding. Perineal numbness also has been documented in women cyclists. In one study, 282 female members of a Dallas cycling club were surveyed. In this group, 34% of the women reported perineal numbness.

In addition, research, such as the Massachusetts Male Aging Study, indicates that men who rode at least three hours per week have a 72 percent greater chance of becoming impotent in comparison to non-riders. Other studies indicate that cyclists are twice as likely to become impotent than other athletes. One study estimated that approximately four percent of male cyclists are impotent.

The human rear is designed to support the weight of the body on two “sit bones.” When sitting on a chair, a person sits on his or her ischial tuberosities (See FIG. 1), the skeletal structures commonly referred to as the “sit bones”, and distributes his or her weight over a wide surface area over the sit bones. In addition, the sit bones are protected by muscle and fat and have no arteries or nerves that could be compressed or crushed by the weight of the person.

It is a different story when a person straddles a narrow bicycle seat. His or her weight is distributed over a much smaller area. A typical bicycle seat directs most, if not all, the pressure from the weight of the rider away from the sit bones on to the perineum, that part of the body that contains the nerves and blood vessels to the genitals. Anatomically, the ischial pubic ramos (i.e., ischial bones) connects the ischial tuberosities to the pubic bone (See FIG. 1). The internal portion of the male and female genitals are then attached to the ischial bones to give those organs structural support. When a person straddles a narrow bicycle seat, the weight of the person is not supported by the sit bones, but rather by the ischial bones. In such a case, studies have shown that the nerves, such as the perineal nerves, and blood vessels, such as the pudendal arteries, running within the Alcock canals that are enclosed laterally by the ischial bones can be compressed within the canals between the horn portion of the bicycle seat and the ischial bones. It has been shown that it takes only about 11% of the body weight of a rider to compress the nerves and vessels in the perineum. Prolonged pressure to these nerves and vessels in the perineum can result in bicycle seat neuropathy.

Pressure is measured by weight divided by surface area. Thus, the larger the bicycle seat, the less pressure, for instance, per square inch. It should be noted that when leaning forward in a bicycle seat to get into an aerodynamic position, a rider typically moves forward onto the nose portion of the bicycle seat. In such a position, even more pressure is exerted on the nerves and vessels in the perineum, as these nerves and vessels are pressed against the horn portion of the bicycle seat. This increased pressure has been shown to be greater than blood can typically flow into the area. It has been postulated that prolonged or constant compression of the perineum can damage the nerves and decrease blood flow in the vessels in the area, resulting in, for example, erectile dysfunction.

To address the effect of bicycle seat neuropathy on erectile dysfunction, some riders have switched to recumbent bicycles in which the riders sit reclined and peddle with their legs stretched out in front. Others have used wider saddles, thus increasing the surface area of the seat to help decrease pressure to the perineum. Bicycle seat manufacturers have also attempted to redesign the bicycle seat to minimize pressure to the perineum. For instance, certain bicycle seats have been designed to have a large oval cutout in the middle of the seat, so as not to exert pressure on the perineum. Others are designed with two adjacent but independent parallel seat portions upon which each sit bone may rest, while still others have a long groove down the middle of the seat.

These designs, although may be novel, does not completely eliminate pressure being exerted against the perineal nerves and vessels between the ischial bones and the horn portion of the bicycle seat. To address this, there is commercially available a seat design that provides a two independent noseless (i.e., hornless) seat portions. Studies of this seat have shown that there is unchanged blood flow in the perineal vessels, whereas there is no blood flow using a saddle with or without a cutout in the center of the seat.

However, the use of a hornless seat can interfere with the ability of the rider to perform a turn, especially a sharp turn, on the bicycle. In particular, with a traditional bicycle seat, as a rider performs a turning maneuver, he/she typically uses his/her inner thigh to engage the horn portion of the seat while leaning into the turn for balancing purposes. When a seat lacks a horn portion, there is not a place for engagement by the inner thigh. As such, the turn may be inherently more unstable and could lead to undesirable accidents.

Accordingly, it would be desirable to provide a bicycle seat that would eliminate, minimize and/or divert pressure typically exerted on the perineal nerves and vessels of a rider, so as to minimize the incidence of bicycle seat neuropathy, while maintaining for the rider the ability to perform turning maneuvers without compromising the stability needed for the turn.

### SUMMARY OF THE INVENTION

The present invention provides, in one embodiment, a bicycle seat that can eliminate or minimize the incidence of bicycle seat neuropathy. The bicycle seat, by its design, may also be used to permit a rider to perform turning maneuvers without compromising the stability needed for the turn.

In accordance with one embodiment of the present invention, a bicycle seat is provided with a platform portion having an upper surface upon which opposing ischial bones of a rider can be supported. The seat may also include a horn portion extending axially forward of the platform portion, and a depression positioned between the platform portion and the horn portion. The platform portion, in an embodiment, tapers into the horn portion, and includes an area adjacent the horn portion that is sufficiently wide to span a space between the opposing ischial bones and to support the ischial bones. The depression, on the other hand, includes a substantially uniform depth, so as to allow the rider in a riding position to avoid pressure against the nerves and vessels adjacent the ischial bones and genital area, and to minimize damages to those nerves and vessels. The horn portion, in one embodiment, includes a sufficient length to permit engagement by the inner thigh of the rider for balancing purposes when performing a turning maneuver.

In accordance with another embodiment of the present invention, a method for minimizing bicycle seat neuropathy is provided. The method includes providing a seat having a platform upon which opposing ischial bones of a rider can be supported, a horn portion extending axially forward of the platform, and a depression situated between the platform portion and the horn portion. Next, the rider may be permitted to sit on the seat such that the ischial bones are supported on the platform. Thereafter, the position of the rider on the seat may be adjusted, so as to permit the nerves and vessels adjacent the ischial bones and genital area of the rider to be situated substantially in the area of the depression.

### BRIEF DESCRIPTION OF THE DRAWINGS

The invention is explained in greater detail below with reference to an exemplary embodiment that is illustrated in the accompanying figures.

FIG. 1 illustrates a front view of a human pelvic bone.

FIG. 2 illustrates a top view of bicycle seat in accordance with an embodiment of the present invention.

FIG. 3 illustrates a side view of the bicycle seat shown in FIG. 1.

FIG. 4 illustrates an ultrasound graph measuring blood flow in the cavernosal penile arteries of a test subject sitting upright on a chair.

FIG. 5A illustrates an ultrasound graph measuring blood flow in the cavernosal penile arteries of a test subject sitting in a riding position on the seat of the present invention.

FIG. 5B illustrates an ultrasound graph measuring blood flow in the cavernosal penile arteries of a test subject sitting in a riding position on the seat of the present invention with a spacer-block in the depression.

FIG. 6A illustrates an ultrasound graph measuring blood flow in the cavernosal penile arteries of a test subject sitting in a riding position on a traditional bicycle seat with a depression cut into the seat between the horn portion and the platform portion.

FIG. 6B illustrates an ultrasound graph measuring blood flow in the cavernosal penile arteries of a test subject sitting in a riding position on a traditional bicycle seat without a depression between the horn portion and the platform portion.

### DETAILED DESCRIPTION OF SPECIFIC EMBODIMENTS

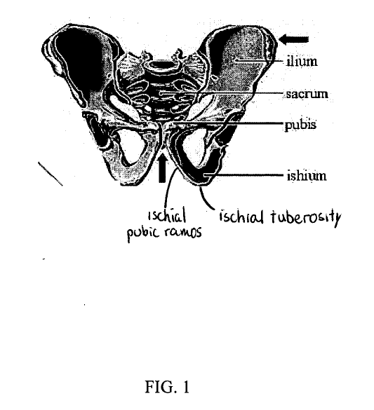

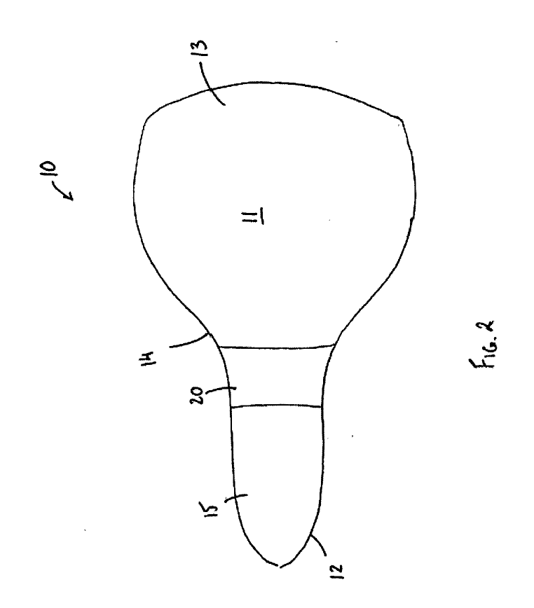

As illustrated in FIG. 2, there is provided a bicycle seat 10 for minimizing bicycle seat neuropathy. The seat 10, in accordance with an embodiment of the present invention, includes a platform portion 11 having an upper surface 13 upon which opposing ischial bones (i.e., ischial pubic ramos of FIG. 1) of a rider can be supported, and a horn portion 12 extending axially forward of the platform portion 11. In one embodiment, the platform portion 11 may be designed to taper toward the horn portion 12, such that the horn portion 12 and the platform portion 11 may be integral with one another. The platform portion 11, in tapering toward the horn portion 12, includes a transition area 14 on the upper surface 13 sufficiently wide to span a space between the opposing ischial bones and to permit the ischial bones to be supported thereon. In an embodiment of the invention, the transition area 14 on the upper surface 13 has a width ranging from about 2.0 inches to about 4.5 inches at a juncture between the horn portion 12 and the transition area 14. It should be appreciated that to the extent seat 10 of the present invention may be specifically designed for a particular rider, the transition area 14 may have a width that varies from the range provided above at the juncture between the horn portion 12 and the transition area 14, so long as the width is sufficient to support the opposing ischial bones.

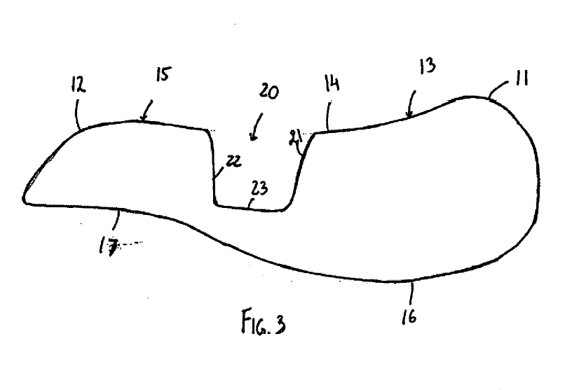

With respect to the horn portion 12, looking now at FIG. 3, in an embodiment of the invention, the horn portion 12 may be designed to include a sufficient length, so that as a rider performs a turning maneuver, the rider may use his or her inner thigh to comfortably engage the horn portion 12 of the seat 10 while leaning into the turn for balancing purposes. In one embodiment, the length of the horn portion 12 should be such that the rider does not have to substantially move backward on the platform portion 11 of the seat 10 to engage the horn portion 12. Moreover, the horn portion 12 may be provided with an upper surface 15 that is at a level substantially similar to the upper surface 13 of the platform portion 11. Furthermore, it should be appreciated that although illustrated in FIG. 3 as having lower edges 16 and 17 that are at different level, the level at which the lower edge 16 of platform portion 11 and the lower edge 17 of horn portion 12 is situated may be substantially similar, so long as the lower edge of horn portion 12 remains integral with the lower edge of platform portion 11.

Still referring to FIG. 3, the bicycle seat 10 of the present invention may further include a depression 20 positioned between the platform portion 11 and the horn portion 12. The depression 20, in an embodiment, may be defined by an end 21 within or adjacent the transition area 14 on the upper surface 13 of the platform portion 11. The depression 20 may also include an opposite end 22 adjacent the horn portion 12 and a lower surface 23 extending between the ends 21 and 22. Ends 21 and 22, in one embodiment, may be substantially perpendicular to the lower surface 23, or may taper or slope upward toward upper surfaces 13 and 15 respectively, or a combination thereof. Should it be desired, the depression 20 may be designed to include only end 21, so that the lower surface 23 extend from end 21 adjacent the transition area 14 substantially along the length of the horn portion 12.

The presence of depression 20, in one embodiment, minimizes or prevent pressure against the perineum, when the rider is situated on seat 10 with the opposing ischial bones supported on the transition area 14 or on the platform portion 11. In particular, the nerves, such as the perineal nerves, and blood vessels, such as the pudendal arteries, running within the Alcock canals that are enclosed laterally by the ischial bones, may now be situated over and/or within the depression 20, such that these nerves and vessels will not be compressed within the Alcock canal between the horn portion 12 or the transition area 14 and the ischial bones. It should be appreciated that in minimizing or preventing prolonged pressure to the nerves and vessels in the perineum, the incidence of bicycle seat neuropathy can be minimized or prevented.

To enhance the accommodation of the perineal nerves and vessels over and/or within the depression 20, the depression 20 may be provided with a substantially uniform depth from end 21 adjacent the transition area 14 along the lower surface 23. In accordance with one embodiment of the invention, the depression 20 may be designed to include a depth that is at least from about 0.10 inches to about 0.15 inches from the upper surface 13 of the platform 11, when the weight from the rider, in the riding position, is exerted on the platform portion 11. In this manner, the perineal nerves and vessels may clear the lower surface 23 of the depression 20 when the rider is situated on seat 10.

In use, the seat 10, as described above, may be provided on a bicycle (not shown) in place of a traditional or other commercially available seat. In preparation for a ride, the rider may mount the bicycle and thereafter position himself or herself on to the seat 10, such that the opposing ischial bones are supported on the platform portion 11 or on the transition area 14. Subsequently, the rider may adjust his or her position on the seat 10, so as to permit the nerves and vessels within the perineum to be situated substantially above and/or within the depression 20. The rider may then initiate pedaling to begin the ride. Should the rider be interested in moving into an aerodynamic position on the seat 10 to increase the pace of the ride, and thus the speed of the bicycle, it should be appreciated that seat 10 is designed so that even in such an aerodynamic position, the perineal nerves and vessels can remain accommodated above and/or within the depression 20.

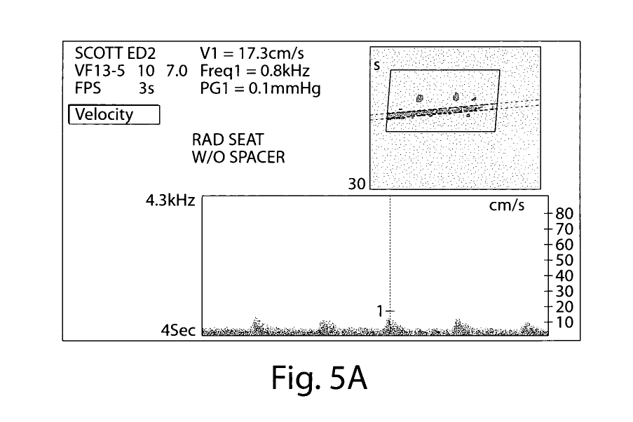

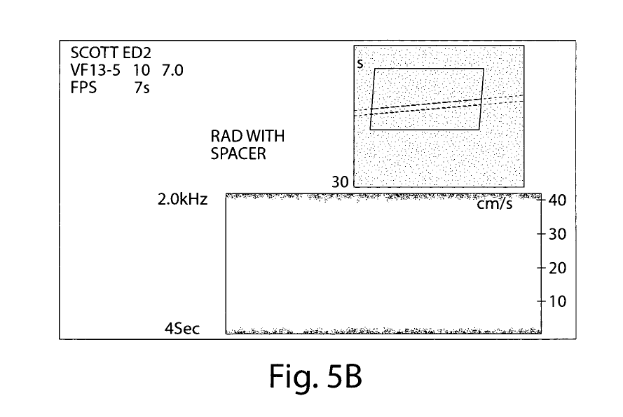

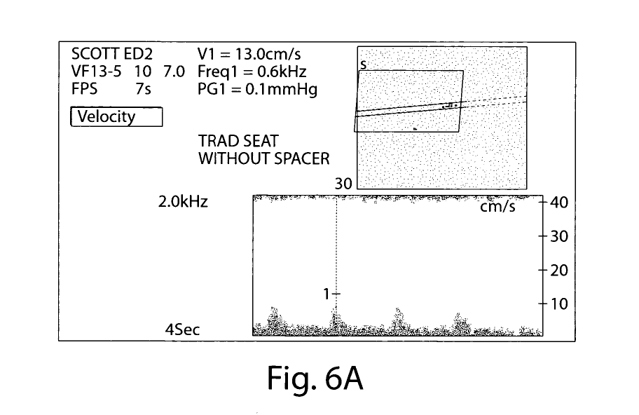

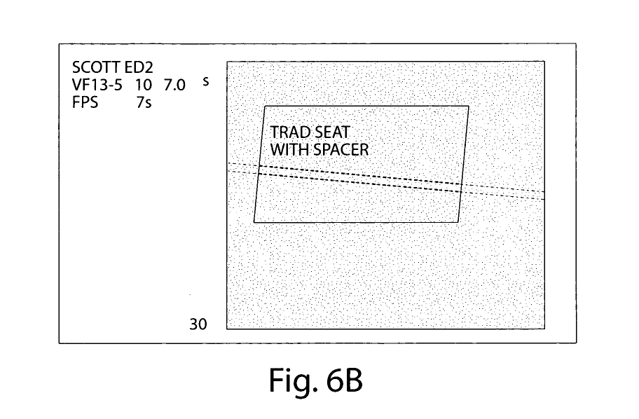

As is illustrated hereinafter, evidence of substantially normal blood flow in the blood vessels within the Alcock canal of the perineum can be clearly demonstrated in various ultrasound tests measuring the blood flow in the subject's right and left cavernosal penile arteries when doing a comparison of observed blood flow (1) in a bicycle seat of the present invention having a depression between the horn portion and the platform portion (FIG. 5A) against one that has a spacer-block placed in the depression to simulate a traditional bicycle seat (FIG. 5B), and (2) in a traditional bicycle seat that has a depression cut into it between the horn portion and the platform portion (FIG. 6A) against one that does not have depression (FIG. 6B).

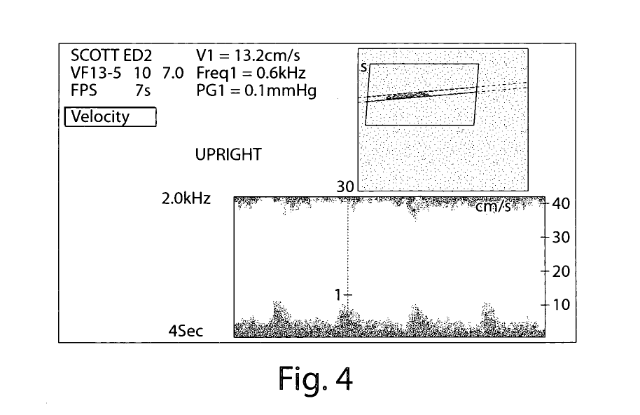

In FIG. 4, there is shown a graph measuring the blood flow in the cavernosal arteries when the subject is sitting upright on a chair wherein his weight is supported by the sit bones and not the ischial bones. This graph provides a control where evidence of blood flow, as illustrated by the spike activities at the bottom of the graph, is observed at a rate of about 13.2 cms per second in the cavernosal arteries of the subject sitting upright on the sit bones.

In FIG. 5A, there is shown a graph measuring the blood flow in the cavernosal arteries when the subject is in a riding position on the seat of the present invention, i.e., one with a depression similar to that in seat 10 above. As can be seen by the spike activities at the bottom of the graph, blood flow is observed at a rate of about 17.3 cms per second in the cavernosal arteries of the subject on such a seat.

In contrast, in FIG. 5B, substantially no blood flow is observed (substantially no spike activity is observed at the bottom of the graph) in the cavernosal arteries of the subject when the subject is positioned on the seat of the present invention that has a spacer-block in the depression to simulate a traditional bicycle seat, i.e., one without a depression.

In FIG. 6A, there is shown a graph measuring blood flow in the cavernosal arteries when the subject is in the riding position on a traditional bicycle seat that has a depression cut into it between the horn portion and the platform portion. As illustrated, blood flow, evidenced by the spike activities at the bottom of the graph, is observed at a rate of about 13.0 cms per second in the cavernosal arteries of the subject on this seat.

In contrast, in FIG. 6B, when the subject is in the riding position on the traditional bicycle seat without a depression cut into it, substantially no blood flow is observed.

As the results indicate, there is a significant measurable and observable difference in the rate of blood flow between the use of a bicycle seat, traditional or that of the present invention, provided with a depression between the horn portion and the platform portion, and the use of a bicycle seat without such a depression. This observed and measurable difference can be directly correlated to the lack of pressure exerted on the cavernosal arteries of the subject, when the subject is on a seat provided with a depression, similar to that of the present invention. In contrast, when the subject is on the traditional bicycle seat or the seat of the present invention with a spacer-block in the depression, i.e., without a depression, pressure is exerted against the cavernosal arteries between the ischial bones and the seat or spacer-block, when the subject is in the riding position, resulting in substantially no observed blood flow.

While the invention has been described in connection with the specific embodiments thereof, it will be understood that it is capable of further modification. Furthermore, this application is intended to cover any variations, uses, or adaptations of the invention, including such departures from the present disclosure as come within known or customary practice in the art to which the invention pertains, and as fall within the scope of the appended claims.

1. A bicycle seat comprising:
a platform portion having an upper surface upon which opposing ischial bones of a rider can be supported;
a horn portion extending axially forward of the platform portion; and
a depression, positioned between the platform portion and the horn portion, and extending completely from one side of the seat to the other, so that in a riding position, pressure against nerves and vessels adjacent the ischial bones and genital area of the rider can be avoided to minimize damages to those nerves.

2. A bicycle seat as set forth in claim 1, wherein the platform portion tapers toward the horn portion and includes an area adjacent thereto on the upper surface sufficiently wide to span a space between the opposing ischial bones and to support the ischial bones.

3. A bicycle seat as set forth in claim 2, wherein the depression includes one end within the area where the upper surface is sufficiently wide to span a space between the opposing sit bones of the rider.

4. A bicycle seat as set forth in clam 2, wherein the depression includes one end within the area where the upper surface has a width ranging from about 2.0 inches to about 4.5 inches wide.

5. A bicycle seat as set forth in claim 2, wherein the depression includes a substantially uniform depth, such that in the riding position, pressure from the either the platform portion or the horn portion against those nerves and vessels adjacent the ischial bones and genital areas can be avoided.

6. A bicycle seat as set forth in claim 2, wherein the depression includes a depth that is at least from about 0.10 inches to about 0.15 inches from the upper surface of the platform portion, in the riding position when weight from the rider is exerted on the platform portion.

7. A bicycle seat as set forth in claim 1, wherein the horn portion includes an upper surface substantially at the same level as that of the platform portion.

8. A bicycle seat as set forth in claim 1, wherein the horn portion includes a sufficient length to permit engagement by a rider's inner thighs for balancing purposes when performing a turning maneuver.

9. A bicycle seat as set forth in claim 1, wherein the horn portion and the platform portion are integral with one another.

10. A method for minimizing bicycle seat neuropathy, the method comprising:
providing a seat having a platform upon which opposing ischial bones of a rider can be supported, a horn portion extending axially forward of the platform, and a depression situated between the platform portion and the horn portion, the depression extending completely from one side of the seat to the other;
allowing the rider to sit on the seat such that the ischial bones are supported on the platform; and
adjusting the position of the rider on the seat to permit the nerves and vessels adjacent the ischial bones and genital area of the rider to be situated substantially above the depression.

11. A method as set forth in claim 10, wherein the step of allowing includes permitting the rider to sit on the seat in an aerodynamic position.
